(19) United States
(12) Patent Application Publication
(10) Pub. No.: US 2025/0203183 A1
(43) Pub. Date: Jun. 19, 2025

(54) CAMERA MODULE AND METHOD OF MANUFACTURING THE SAME

(71) Applicant: SAMSUNG ELECTRO-MECHANICS CO., LTD., Suwon-si (KR)

(72) Inventors: Jaehun LEE, Suwon-si (KR); Junyeol LEE, Suwon-si (KR); Jangho OH, Suwon-si (KR); Jinseong KIM, Suwon-si (KR); Kyungho BAEK, Suwon-si (KR)

(73) Assignee: SAMSUNG ELECTRO-MECHANICS CO., LTD., Suwon-si (KR)

(21) Appl. No.: 18/896,424

(22) Filed: Sep. 25, 2024

(30) Foreign Application Priority Data
Dec. 19, 2023 (KR) 10-2023-0185956

(51) Int. Cl. H04N 23/51; G03B 30/00; H04N 23/54

(52) U.S. Cl. CPC H04N 23/51; G03B 30/00; H04N 23/54

(57) ABSTRACT

A camera module includes a lens barrel in which at least one lens is disposed; a housing configured to support the lens barrel; a fixing pin that protrudes from the housing and extends in an optical axis direction; a sensor board having first and second surfaces opposite to each other, and a pin insertion hole into which the fixing pin is inserted; and a soldering part, disposed in the pin insertion hole, that protrudes from first and second surfaces of the sensor board, and fixes the fixing pin.

### CROSS-REFERENCE TO RELATED APPLICATIONS

This application claims the benefit under 35 USC 119(a) of Korean Patent Application No. 10-2023-0185956 filed on Dec. 19, 2023, in the Korean Intellectual Property Office, the entire disclosure of which is incorporated herein by reference for all purposes.

### BACKGROUND

### 1. Field

The present disclosure relates to a camera module and a method of manufacturing the same.

### 2. Description of the Background

Autonomous and unmanned vehicles include higher-performance electronic cameras. Both new and established electronic component companies desire an increasing number of new camera developments. Wide field of view (WFoV) cameras with an angle of view of 180 degrees or more and narrow field of view (NFoV) cameras with an angle of view of 52 degrees or less are accelerating in development to provide peripheral perception from the front side. In addition, as camera performance develops, high-definition (5 to 12 M) sensors for improved recognition and lenses with various angles of view are being developed.

Active alignment, a process of placing a lens on an image sensor, may be used when manufacturing camera modules. During the active alignment process, it may be desirable to precisely adjust the focal point of the lens so that the focal point of the lens is accurately aligned with the image sensor. Thus, a resin bonding agent, such as epoxy, may be applied to fix the lens housing and a sensor board. The resin bonding agent contracts or expands during a curing process, and a defocusing deviation may occur to cause a process defect.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more general aspects, a camera module includes a lens barrel in which at least one lens is disposed; a housing configured to support the lens barrel; a fixing pin that protrudes from the housing and extends in an optical axis direction; a sensor board having first and second surfaces opposite to each other, and a pin insertion hole into which the fixing pin is inserted; and a soldering part, disposed in the pin insertion hole, that protrudes from first and second surfaces of the sensor board, and fixes the fixing pin.

The pin insertion hole may be a through-hole.

The soldering part may be partially disposed on the first surface and the second surface of the sensor board.

The soldering part may be disposed on the first surface and the second surface to cover an edge of the pin insertion hole while surrounding the fixing pin.

The housing may have a bottom surface facing the first surface of the sensor board, and the fixing pin may extend from the bottom surface toward the first surface of the sensor board.

The fixing pin may be inserted into the pin insertion hole from the first surface of the sensor board to protrude from the second surface of the sensor board.

The portion of the soldering part disposed in the pin insertion hole may be connected to another portion of the soldering part disposed on the first surface or the second surface.

The fixing pin may include a metallic material.

The sensor board may include an image sensor mounted on the first surface.

The soldering part may include a thermally curing solder paste surrounding the fixing pin in the pin insertion hole.

The soldering part may include laser beam thermally cured solder paste.

In another general aspect, a method of manufacturing a camera module having a housing configured to support a lens barrel fixed to a sensor board includes disposing a solder material on a pin insertion hole extending through surfaces of the sensor board; inserting a fixing pin of the housing into the pin insertion hole; performing active alignment while moving the housing; and curing the solder material to fix the fixing pin in the pin insertion hole.

The curing may include irradiating the solder material with laser beams after performing the active alignment.

The disposing of the solder material may include applying solder paste in the pin insertion hole.

The applying of the solder paste may include applying the solder paste in the pin insertion hole and a portion of one of the surfaces of the sensor board.

The inserting of the fixing pin may include inserting the fixing pin when the pin insertion hole is filled with the solder paste.

The disposing of the solder material may include seating a solder ring on the sensor board.

The curing may include laser-welding the solder ring.

In another general aspect, a camera module having a housing configured to support a lens barrel includes a fixing pin configured to protrude from the housing and extend in an optical axis direction; a sensor board having opposing surfaces and a pin insertion hole extending through the opposing surfaces; and a soldering part, disposed in the pin insertion hole, configured to protrude from the opposing surfaces of the sensor board and fix the fixing pin.

The soldering part may be partially disposed on the opposing surfaces of the sensor board, and the fixing pin may extend from a bottom surface of the housing toward one of the opposing surfaces of the sensor board.

Other features and aspects will be apparent from the following detailed description, the drawings, and the claims.

### BRIEF DESCRIPTION OF DRAWINGS

FIG. 1 is a cross-sectional view schematically illustrating a camera module according to an embodiment.

FIG. 2 is a flowchart explaining a method of manufacturing a camera module according to another embodiment.

FIG. 3 is a cross-sectional view of the camera module illustrated to explain the method of manufacturing the camera module illustrated in FIG. 2.

FIGS. 4 to 6 are enlarged cross-sectional views illustrating a pin insertion hole of a sensor board illustrated to explain the method of manufacturing the camera module illustrated in FIG. 2.

FIG. 7 is a flowchart for explaining a method of manufacturing a camera module according to still another embodiment.

FIG. 8 is a cross-sectional view of the camera module illustrated to explain the method of manufacturing the camera module according to still another embodiment.

FIGS. 9 and 10 are enlarged cross-sectional views illustrating a pin insertion hole of a sensor board illustrated to explain the method of manufacturing the camera module illustrated in FIG. 7.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

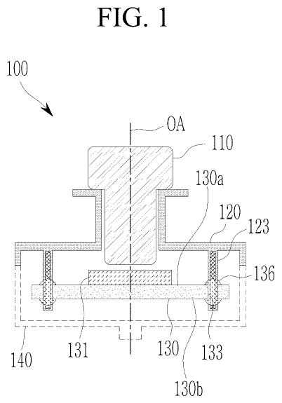

FIG. 1 is a cross-sectional view schematically illustrating a camera module according to an embodiment.

In FIG. 1, a camera module 100, according to the present embodiment, includes a lens barrel 110, an upper housing 120 configured to support the lens barrel 110, and a sensor board 130 on which an image sensor 131 is mounted. The upper housing 120 may be fixedly coupled to the sensor board 130. At least one lens (not illustrated) may be disposed in the lens barrel 110. When a plurality of lenses is provided, the plurality of lenses may be mounted in the lens barrel 110 along an optical axis OA.

Fixing pins 123 may protrude from the upper housing 120. The fixing pin 123 may protrude from a bottom surface of the upper housing 120 and extend in an optical axis direction.

The fixing pin 123 may be provided as a plurality of fixing pins 123 disposed around the image sensor 131. The fixing pin 123 may be made of a metallic material. The fixing pin 123 may be made of the same material as the upper housing 120 and integrated with the upper housing 120. Alternatively, the fixing pin 123 may be made of a material different from the material of the upper housing 120 and configured to be separable from the upper housing 120. For example, the fixing pin 123 integrated with the upper housing 120 may include aluminum (Al). The fixing pin 123 is configured to be separable from the upper housing 120 and may include nickel (Ni) and tin (Sn). The separable fixing pin 123 may be fixedly inserted into a coupling groove formed on the bottom surface of the upper housing 120.

The upper housing 120 may be coupled to a lower housing 140 configured to cover the sensor board 130. The upper housing 120 and the lower housing 140 may be coupled to each other to constitute a housing of the camera module 100. The sensor board 130, on which the image sensor 131 is mounted, may be disposed in a space defined by coupling the upper housing 120 and the lower housing 140.

The sensor board 130 has first and second surfaces 130a and 130b opposite each other. The first surface 130a may be a surface facing the lens barrel 110, and the image sensor 131 may be mounted on the first surface 130a. The sensor board 130 has pin insertion holes 133, through holes that penetrate the sensor board 130 from the first surface 130a to the second surface 130b. The fixing pin 123 protruding from the upper housing 120 may be inserted into the pin insertion hole 133.

The bottom surface of the upper housing 120 may face the first surface 130a of the sensor board 130, and the fixing pin 123 may extend from the bottom surface to the first surface 130a. In this case, the fixing pin 123 may be inserted into the pin insertion hole 133 from the first surface 130a of the sensor board 130, protrude from the second surface 130b, and penetrate the sensor board 130.

A soldering part 136 may be disposed in the pin insertion hole 133 to fix the fixing pin 123 inserted into the pin insertion hole 133. The soldering part 136 may be located on the first surface 130a and the second surface 130b of the sensor board 130. The soldering part 136 disposed on the first surface 130a and the second surface 130b may protrude on the surface of the sensor board 130. In addition, the soldering part 136 may be provided on the first surface 130a and the second surface 130b and configured to cover an edge of the pin insertion hole 133 while surrounding the fixing pin 123. A portion of the soldering part 136, disposed in the pin insertion hole 133, may be connected to another portion of the soldering part 136 disposed on the first surface 130a or the second surface 130b.

The soldering part 136 may be thermally cured by irradiating a solder material with laser beams. The solder material may be solder paste or a solder ring. The cured soldering part 136 may be obtained by laser-welding the solder paste disposed in the pin insertion hole 133 or the solder ring seated on the sensor board 130 on the pin insertion hole 133.

When the solder paste is applied as the solder material, an active alignment process of positioning the solder paste in the pin insertion hole 133 and moving the fixing pin 123 in the optical axis direction in the pin insertion hole 133 may be performed. The solder paste may be thermally cured by the laser beams after the active alignment process, such that the position of the fixing pin 123 may be fixed in the pin insertion hole 133. Therefore, the position of the upper housing 120 with respect to the sensor board 130 may also be fixed, and the position of the lens barrel 110 with respect to the image sensor 131 may also be fixed.

When the solder ring is applied as the solder material, the center opening 235a of the solder ring is positioned on the sensor board 130 to correspond with the pin insertion hole 133, and the active alignment process may be performed while the fixing pin 123 moves in the optical axis direction within the pin insertion hole 133. Laser beams may melt the solder ring, and after the active alignment process, the position of the fixing pin 123 may be fixed in the pin insertion hole 133 after curing.

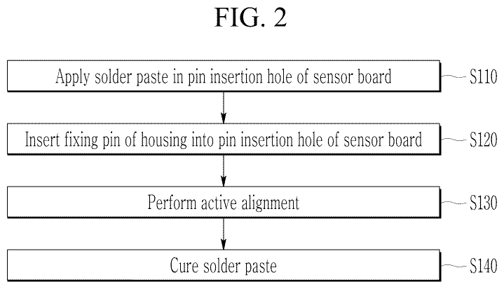

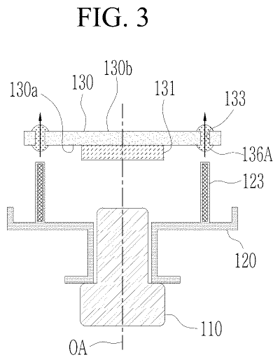

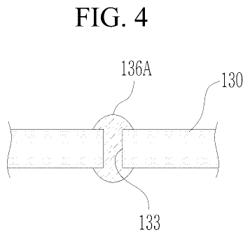

FIG. 2 is a flowchart explaining a method of manufacturing a camera module according to another embodiment. FIG. 3 is a cross-sectional view of the camera module illustrated to explain the method of manufacturing the camera module illustrated in FIG. 2. FIGS. 4 to 6 are enlarged cross-sectional views illustrating a pin insertion hole of a sensor board illustrated to explain the method of manufacturing the camera module illustrated in FIG. 2.

The method of manufacturing the camera module 100, according to the present embodiment, includes a process of performing the active alignment on the upper housing 120, in which the lens barrel 110 is supported, and then fixing the upper housing 120 to the sensor board 130. At least one lens (not illustrated) may be disposed in the lens barrel 110. For example, a plurality of lenses may be mounted in the lens barrel 110 along the optical axis OA.

The fixing pin 123 may protrude from the bottom surface of the upper housing 120 and extend in the optical axis direction. The sensor board 130 has the first and second surfaces 130a and 130b opposite each other. The first surface 130a may be a surface facing the lens barrel 110, and the image sensor 131 may be mounted on the first surface 130a. The sensor board 130 also has pin insertion holes 133, provided as through-holes.

With reference to FIG. 2, according to the method of manufacturing the camera module 100 according to the present embodiment, solder paste 136A is applied in the pin insertion hole 133 of the sensor board 130 (S110). The solder paste 136A is a material in a soft state that, if not heat-cured, allows the active alignment to be performed by inserting the fixing pin 123. With reference to FIG. 4, the solder paste 136A may also be applied in the pin insertion hole 133 and applied onto a portion of the surface of the sensor board 130. The solder paste 136A may be applied onto the surface of the sensor board 130 and applied at the periphery, including the edge of the pin insertion hole 133.

Next, with reference to FIGS. 3 and 4, the upper housing 120 or the sensor board 130 is moved, such that the fixing pin 123 is inserted into the pin insertion hole 133 (S120). The fixing pin 123 may reciprocate in the optical axis direction in the pin insertion hole 133. The fixing pin 123 may be inserted into the pin insertion hole 133 in the state where the pin insertion hole 133 is filled with the solder paste 136A. In this case, the fixing pin 123 may be surrounded by the solder paste 136A with which the pin insertion hole 133 is filled. However, because the solder paste 136A is in a soft state before the solder paste 136A is thermally cured, the fixing pin 123 remains movable.

Next, an active alignment is performed while moving the upper housing 120 relative to the sensor board 130 (S130). The active alignment is an optical axis alignment process of placing the lens on the image sensor when manufacturing the camera module. An active alignment device may be used to precisely align a camera lens part and an image sensor part, and the image sensor and the optical axis may be aligned so that the image sensor and the focal point of the lens are accurately consistent with each other.

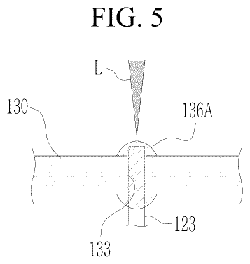

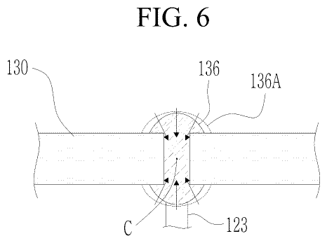

Next, with reference to FIGS. 5 and 6, soldering is performed by thermally curing the solder paste 136A (S140). After the active alignment is performed, the soldering may be performed by irradiating the solder paste 136A with laser beams L. The entire fixing pin 123 and the entire solder paste 136A may be uniformly irradiated with the laser beams L. When the solder paste 136A is irradiated with the laser beams L, the solder paste 136A may be instantaneously cured while being contracted in a direction toward a center C. In this way, the solder paste 136A may be thermally cured and contracted to form the soldering part 136.

The soldering part 136 is cured, such that the fixing pin 123 may be fixed in the pin insertion hole 133. The solder paste 136A may not only be applied in the pin insertion hole 133, but also be applied onto the surface of the sensor board 130. Therefore, the cured soldering part 136 may be disposed around the pin insertion hole 133 and protrude from the surface of the sensor board 130.

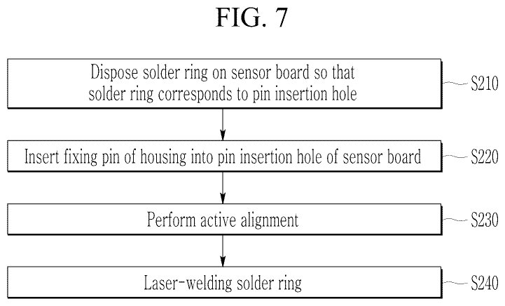

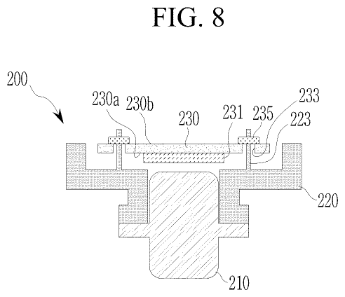

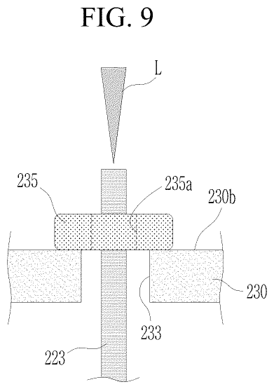

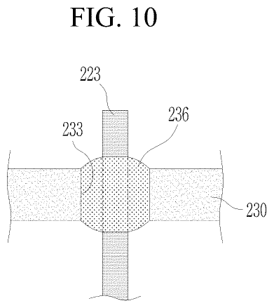

FIG. 7 is a flowchart for explaining a method of manufacturing a camera module according to still another embodiment. FIG. 8 is a cross-sectional view of the camera module illustrated to explain the method of manufacturing the camera module according to still another embodiment. FIGS. 9 and 10 are enlarged cross-sectional views illustrating a pin insertion hole of a sensor board illustrated to explain the method of manufacturing the camera module illustrated in FIG. 7.

With reference to FIGS. 7 and 8, according to the manufacturing method of the present embodiment, a solder ring 235 is disposed on a sensor board 230 to correspond to a pin insertion hole 233 (S210). The solder ring 235 may be formed into a ring-shaped solder member with an open center by molding a solder material. The solder ring 235 may be seated on a second surface 230b of the sensor board 230 so that the center opening 235a corresponds to the pin insertion hole 233. That is, the solder ring 235 may be seated in advance on the sensor board 230 before the active alignment is performed. The second surface 230b may be a surface opposite to a first surface 230a on which an image sensor 231 is mounted.

Next, the upper housing 220 or the sensor board 230 is moved such that a fixing pin 223 is inserted into the pin insertion hole 233 (S220). The fixing pin 223 may reciprocate in the optical axis direction in the pin insertion hole 233. Because the center opening 235a of the solder ring 235 is disposed to correspond to the pin insertion hole 233, the fixing pin 223 may move while passing through the pin insertion hole 233 and the center opening 235a of the solder ring 235. In this case, a diameter of the pin insertion hole 233 and a diameter of the center opening 235a of the solder ring 235 are larger than a diameter of a transverse section of the fixing pin 223, such that a motion of the fixing pin 223 may not be restricted.

Next, the active alignment is performed while moving an upper housing 220 relative to the sensor board 230 (S230). Because a lens barrel 210 is fixedly supported in the upper housing 220, the lens barrel 210 may also move when the upper housing 220 operates. The active alignment device may be used to precisely align the camera lens part and the image sensor part, and the image sensor and the optical axis may be aligned so that the image sensor and the focal point of the lens are accurately consistent with each other.

Next, with reference to FIGS. 9 and 10, the fixing pin 223 is soldered in the pin insertion hole 233 by laser-welding the solder ring 235 (S140). When the solder ring 235 is irradiated with the laser beam L, the solder ring 235 is melted and cured simultaneously. The pin insertion hole 233 may be filled with the solder ring 235 as the solder ring 235 irradiated with the laser beam L is melted and flows around the fixing pin 223. In this case, flux may be applied to fixing pin 223 to induce the solder flow. The flux is an acidic mixture that removes metal oxides and implements smooth metallurgical bonds during the soldering process.

The solder material, which fills the pin insertion hole 233, may be quickly cured, such that the fixing pin 223 may be fixed in the pin insertion hole 233, and a soldering part 236 may be formed. Therefore, the upper housing 220 may be fixed to the sensor board 230. The cured soldering part 236 may be disposed to protrude upward and downward from the surface of the sensor board 130.

One or more embodiments disclose a method capable of quickly fixing the lens housing and the sensor board during an active alignment process without using epoxy and the curing process.

One or more embodiments disclose a camera module and a method of manufacturing the same, which can quickly fix a lens housing and a sensor board without causing a defect during an active alignment process.

One or more embodiments disclose a camera module and method of manufacturing the same to quickly fix the lens housing and the sensor board without causing a process defect caused by the occurrence of a defocusing deviation during the active alignment process.

In one or more embodiments, after the active alignment process, the lens part and the image sensor part may be soldered and fixed by laser welding, thereby improving the process speed and production ability.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A camera module comprising:
a lens barrel in which at least one lens is disposed;
a housing configured to support the lens barrel;
a fixing pin that protrudes from the housing and extends in an optical axis direction;
a sensor board having first and second surfaces opposite to each other, and a pin insertion hole into which the fixing pin is inserted; and
a soldering part, disposed in the pin insertion hole, that protrudes from first and second surfaces of the sensor board, and fixes the fixing pin.

2. The camera module of claim 1, wherein
the pin insertion hole is a through-hole.

3. The camera module of claim 1, wherein
the soldering part is partially disposed on the first surface and the second surface of the sensor board.

4. The camera module of claim 1, wherein
the soldering part is disposed on the first surface and the second surface to cover an edge of the pin insertion hole while surrounding the fixing pin.

5. The camera module of claim 1, wherein
the housing has a bottom surface facing the first surface of the sensor board, and
the fixing pin extends from the bottom surface toward the first surface of the sensor board.

6. The camera module of claim 1, wherein
the fixing pin is inserted into the pin insertion hole from the first surface of the sensor board to protrude from the second surface of the sensor board.

7. The camera module of claim 1, wherein
a portion of the soldering part disposed in the pin insertion hole is connected to another portion of the soldering part disposed on the first surface or the second surface.

8. The camera module of claim 1, wherein
the fixing pin comprises a metallic material.

9. The camera module of claim 1, wherein
the sensor board comprises an image sensor mounted on the first surface.

10. The camera module of claim 1, wherein
the soldering part comprises a thermally curing solder paste surrounding the fixing pin in the pin insertion hole.

11. The camera module of claim 10, wherein
the soldering part comprises laser beam thermally cured solder paste.

12. A method of manufacturing a camera module having a housing configured to support a lens barrel fixed to a sensor board, the method comprising:
disposing a solder material on a pin insertion hole extending through surfaces of the sensor board;
inserting a fixing pin of the housing into the pin insertion hole;
performing active alignment while moving the housing; and
curing the solder material to fix the fixing pin in the pin insertion hole.

13. The method of claim 12, wherein
the curing comprises irradiating the solder material with laser beams after performing the active alignment.

14. The method of claim 12, wherein
the disposing of the solder material comprises applying solder paste in the pin insertion hole.

15. The method of claim 14, wherein
the applying of the solder paste comprises applying the solder paste in the pin insertion hole and a portion of one of the surfaces of the sensor board.

16. The method of claim 14, wherein
the inserting of the fixing pin comprises inserting the fixing pin when the pin insertion hole is filled with the solder paste.

17. The method of claim 12, wherein
the disposing of the solder material comprises seating a solder ring on the sensor board.

18. The method of claim 17, wherein
the curing comprises laser-welding the solder ring.

19. A camera module having a housing configured to support a lens barrel, the camera module comprising:
a fixing pin configured to protrude from the housing and extend in an optical axis direction;
a sensor board having opposing surfaces and a pin insertion hole extending through the opposing surfaces; and
a soldering part, disposed in the pin insertion hole, configured to protrude from the opposing surfaces of the sensor board and fix the fixing pin.

20. The camera module of claim 19, wherein the soldering part is partially disposed on the opposing surfaces of the sensor board, and
the fixing pin extends from a bottom surface of the housing toward one of the opposing surfaces of the sensor board.
